(19) United States
(12) Patent Application Publication
(10) Pub. No.: US 2007/0005510 A1
(43) Pub. Date: Jan. 4, 2007

(54) System and method for electronic receipt management

(76) Inventors: Willard Bloodworth, Marietta, GA (US); Ricardo Ochoa, Alpharetta, GA (US)

Correspondence Address: SEYFARTH SHAW LLP, 131 S. DEARBORN ST., SUITE2400, CHICAGO, IL, 60603-5803, US

(21) Appl. No.: 11/430,217

(22) Filed: May 8, 2006

Related U.S. Application Data
(60) Provisional application No. 60/679,563, filed on May 10, 2005.

(51) Int. Cl. G06Q 99/00

(52) U.S. Cl. 705/65

(57) ABSTRACT

A system and method for electronic interception and management of receipt information generated by retail cash registers. The system intercepts receipt information while it is in electronic format. Typically, the intended target of the electronic information is a portable electronic device such as a USB device. In a typical embodiment, the merchant can take the customer's USB device and place it into a USB port on the cash register. The receipt data is intercepted and stored on the USB device instead of being printed on a receipt. A consumer can place the device into his or hers personal computer and manipulate the receipt data using money management software programs.

### PRIORITY CLAIM

This application claims priority to and the benefit of U.S. Provisional Application No. 60/679,563 filed on May 10, 2005, the entire contents of which is incorporated herein.

### BACKGROUND

I. Field of the Invention The present invention relates generally to the field of financial transactions, and more particularly to a system and method for electronic receipt management.

II. Description of the Related Art.

Presently, when a retail consumer makes a purchase, the consumer receives a paper receipt from the merchant. For various reasons, including personal and business accounting, the paper receipt must be retained in order to reconcile various accounts. As such, consumers often have numerous receipts that must be retained for long periods of times, often years. In addition, having a paper receipt requires an extra step of having to enter the receipt information into an accounting database to properly record the purchase.

### SUMMARY

The present invention is a system and method for electronic interception and management of receipt information generated by retail cash registers. Presently, electronic (and other) cash registers produce a paper receipt that is received by a purchaser. The present invention intercepts the receipt information while it is in electronic format. The intended target of the electronic information is a portable electronic device. Presently, the primary embodiment for the portable electronic device is a Universal Serial Bus (USB) memory stick. In a typical embodiment, the merchant can take the customer's USB device and place it into a USB port on the cash register. The receipt data is then stored on the portable device instead of printed on a receipt. The portable device therefore maintains a data base of purchases. It is further contemplated that the consumer can place the device into his or hers personal computer. In this way the database can be accessed by money management software programs such as Quicken®. It is contemplated that the portable device can be put into other form factors. In a more complex embodiment, a credit or debit card can include a receipt database that can be advantageously intercepted when the card is swiped. In this way, the receipt information is stored on the card similar to how it would be stored on the USB device. Other form factors are further contemplated. The instructions would include scanning the port for a device. If the device is present, then allow it to intercept the data. It is further understood that many cash registers would require retrofitting, say from serial ports to USB ports. Peripheral equipment could be used to make this retrofit.

In general, in one aspect, the invention features an electronic receipt management system, including a point of sale transaction device that produces receipt data relating to a transaction, a memory device for interfacing with the point of sale transaction device and a process residing on the point of sale transaction device, the process including instructions to detect the receipt data once the receipt data is generated, detect the presence of the memory device interface with the point of sale transaction device and write the receipt data to the memory device if the memory device is interfaced with the point of sale transaction device.

In one implementation, the point of sale transaction device is a cash register.

In another implementation, the memory device is a memory disk.

In another implementation, the memory device is a Universal Serial Bus device.

In another implementation, the memory device is onboard memory on a credit card.

In another implementation, the memory device is onboard memory on a debit card.

In still another implementation, the system further includes a personal computing device for interfacing with the memory device and a process residing on the personal computing device, the process including instructions to detect the receipt data stored on the memory device download the receipt data to a memory residing on the personal computing device and optionally storing the receipt data into software processes residing on the personal computing device.

In another implementation, the personal computing device is a personal computer.

In yet another implementation, the software processes include money management software.

In another implementation, the receipt data is used to reconcile personal accounts.

In another implementation, the receipt data is used to reconcile commercial accounts.

In another aspect, the invention features a method for managing receipt data, including generating receipt data related to a transaction in a point of sale device, routing the receipt data to a memory device that is interfaced with the point of sale device, receiving the data on the memory device, interfacing the memory device with a personal computing device receiving the receipt data in a memory of the personal computing device and organizing the receipt data.

One advantage of the invention is that the need for paper receipts is eliminated.

Another advantage of the invention is that electronic receipt data can be quickly, efficiently and accurately stored and downloaded.

Another advantage of the invention is that a consumer can store all electronic receipt data on a single memory device.

Another advantage of the invention is that consumers can be better organized with all receipt data in a centralized electronic location.

Another advantage of the invention is that much less paper is used in unused receipts.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates a system level diagram of an embodiment of an electronic receipt management system.

### DETAILED DESCRIPTION

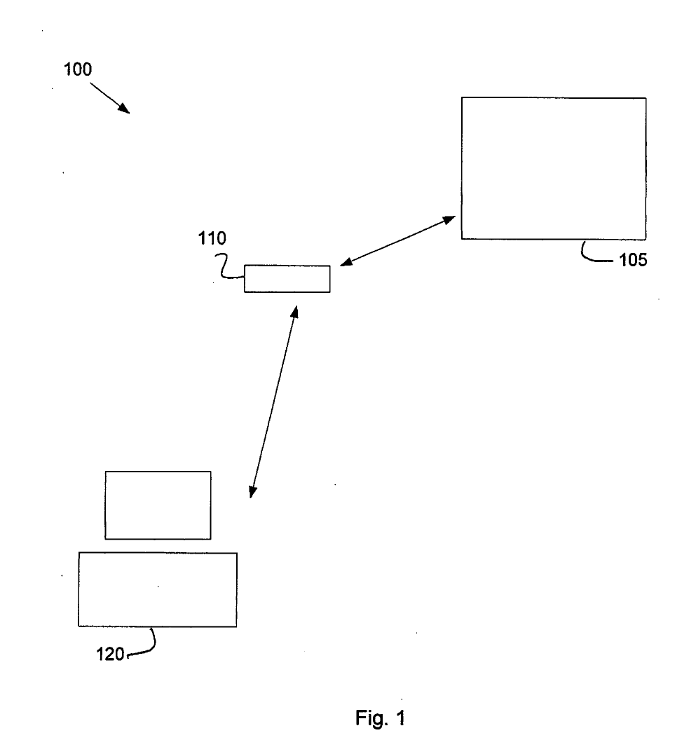

Referring to the drawings wherein like reference numerals designate corresponding parts throughout the several figures, reference is made first to FIG. 1 that illustrates a system level diagram of an embodiment of an electronic receipt management system 100. In general, the system 100 includes a point of sale device 105 such as a cash register that is used to perform typical commercial and financial transactions such as retail sales. In a typical implementation, the device 105 includes a number of electronic interface ports such as a Universal Serial Bus (USB). Typically, most conventional devices such as device 105 include a number of electronic interface ports that can be used to interface with a variety of peripheral equipment.

In general, the system 100 further includes a memory device 110 for interfacing with one or more of the electronic interface ports. In a typical embodiment, the memory device 110 is a USB device used to store data. The memory device 110 can also advantageously be interfaced with a personal computing device 120 such as a personal computer.

Therefore, the electronic receipt management system 100 generally includes a point of sale transaction device 105 that produces receipt data relating to a transaction. It is understood that the receipt data is typically in an electronic format internal to the device 105. The memory device 110 for interfacing with the point of sale transaction device 105 can advantageously be interfaced with one or more of the electronic interface ports on the device 105. It is desirable that one electronic interface port be dedicated for interfacing with the memory device 110 such that a merchant can receive the memory device from each consumer during each transaction such that the memory device can intercept the electronic receipt data, which is normally routed to a printer for a paper receipt. The system 100 therefore typically further includes a process residing on the point of sale transaction device, the process including instructions to detect the receipt data once the receipt data is generated, detect the presence of the memory device 110 interface with the point of sale transaction device; and write the receipt data to the memory device 110 if the memory device is interfaced with the point of sale transaction device 105. In a typical embodiment, the presence of the memory device 110 acts not only to intercept the receipt data for download to the memory device 110, but it also ceases the data from being sent to the port interfaced with the paper printer. In this way, the consumer has the option to obtain the receipt data in electronic format on the memory device 110 rather than having a paper receipt. In other implementations, it is understood that a paper receipt can also be printed.

It is understood that the memory device 110 can have a number of other form factors that allow a consumer to keep an accounting record without the need of paper receipts, as further appreciated below. It is also contemplated that the receipt data can be stored on an onboard memory of credit and/or debit cards that have such capability. In this way, when the card is swiped in the normal course of a transaction, the card is not only used to make the purchase, but the receipt data is stored in the memory. In this way, as appreciated further below, a consumer can automatically keep an accounting record on the same card used to make purchases.

As discussed above, the system 100 can further include the personal computing device 120, such as a personal computer, for interfacing with the memory device 110. In this way, the consumer can take all of the electronic receipt data from the transactions and advantageously download the data to his/her personal (or business) computer for accurate accounting. As such, the personal computing device 120 typically includes a process including instructions to detect the receipt data stored on the memory device, typically in one of the electronic interface ports on the personal computing device 120, download the receipt data to a memory residing on the personal computing device 120 and optionally storing the receipt data into software processes residing on the personal computing device. The software process is typically a money management software package or even a tax package that allows the consumer to automatically download and manage the receipt data without having to be concerned with tracking paper receipts. Therefore, personal and commercial accounts can be quickly, efficiently and accurately reconciled. The memory device can be erased as needed. Paper receipts can optionally be printed. In addition, expense reports can be generated. In a typical implementation, a visual application can be launched to see all of the receipt data in an easy to view and organize manner. The application can prompt the user to insert the memory device; if not already interfaced, and can automatically detect the memory device. Once displayed, the user can view and pick and choose which receipts to manipulate. In another implementation, the user can click on a receipt record to view more detailed information about the receipt, which can vary from merchant to merchant.

In a typical embodiment, the receipt data is also retained electronically on each of the cash registers. In a typical implementation, the merchant can download all of the receipt data to another memory device at the days end or on some other periodic basis as desired, but programming the cash register to download all the receipt data to the specified memory device. In this way; the merchant can also upload the data to another source such as a computer or database.

It is understood that in a typical software implementation, software is required on the merchant register and separate software is required on the target personal computers.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative, only of the principles of the invention. Further, various modifications may be made of the invention ‘without departing from the scope thereof and it is desired, therefore, that only such limitations shall be placed thereon as are imposed by the prior art and which are set forth in the appended claims.

What is claimed is:

1. An electronic receipt management system, comprising:
a point of sale transaction device that produces receipt data relating to a transaction, said point of sale transaction device including a processor;
means for intercepting the receipt data; and
a memory device for interfacing with the intercepting means,
wherein the processor includes instructions to:
(a) detect the receipt data once the receipt data is generated;
(b) detect the presence of the memory device interface with the intercepting means; and
(c) write the receipt data to the memory device if the memory device is interfaced with the intercepting means.

2. The system as claimed in claim 1 wherein the point of sale transaction device is a cash register.

3. The system as claimed in claim 1 wherein the memory device includes at least one of: a memory disk, a Universal Serial Bus device, an onboard memory on a credit card and an onboard memory on a debit card.

4. The system as claimed in claim 1 further comprising:
a personal computing device for interfacing with the memory device; and
a processor residing on the personal computing device, the processor including instructions to:
(i) detect the receipt data stored on the memory device;
(ii) download the receipt data to a memory residing on the personal computing device; and
(iii) optionally storing the receipt data into software processes residing on the personal computing device.

5. The system as claimed in claim 4 wherein the personal computing device is a personal computer.

6. The system as claimed in claim 4 wherein the software processes include money management software.

7. The system as claimed in claim 4 wherein the receipt data is used to reconcile personal accounts.

8. The system as claimed in claim 4 wherein the receipt data is used to reconcile commercial accounts.

9. A method for managing receipt data, comprising:
generating receipt data related to a transaction in a point of sale device;
routing the receipt data to a memory device that is interfaced with the point of sale device;
receiving the data on the memory device;
interfacing the memory device with a personal computing device;
receiving the receipt data in a memory of the personal computing device; and
organizing the receipt data.

10. An electronic receipt management system, comprising:
a point of sale transaction device that produces receipt data relating to a transaction;
means for intercepting the receipt data, said intercepting means including a processor; and
a memory device for interfacing with the intercepting means,
wherein the processor is operable to intercept the receipt data produced by the point of sale transaction device, detect the presence of the memory device and write the receipt data to the memory device if the memory device is interfaced with the intercepting means.

11. The system as claimed in claim 10 wherein the point of sale transaction device is a cash register.

12. The system as claimed in claim 10 wherein the memory device includes at least one of: a memory disk, a Universal Serial Bus device, an onboard memory on a credit card and an onboard memory on a debit card.

13. The system as claimed in claim 10 further comprising:
a personal computing device for interfacing with the memory device; and
a processor residing on the personal computing device, wherein the processor is operable to detect the receipt data stored on the memory device, download the receipt data to a memory residing on the personal computing device and optionally store the receipt data into software processes residing on the personal computing device.

14. The system as claimed in claim 13 wherein the personal computing device is a personal computer.

15. The system as claimed in claim 13 wherein the software processes include money management software.

16. A method for managing receipt data, comprising:
generating receipt data related to at least one transaction associated with a point of sale device;
intercepting the receipt data generated by the point of sale device;
routing the receipt data to a memory device interfaced with the point of sale device;
receiving the data on the memory device;
interfacing the memory device with a personal computing device;
receiving the receipt data in a memory of the personal computing device; and
organizing the receipt data.
